(19) United States
(12) Patent Application Publication
(10) Pub. No.: US 2018/0111085 A1
(43) Pub. Date: Apr. 26, 2018

(54) STEAM GENERATOR

(71) Applicant: Siemens Aktiengesellschaft, Munich (DE)

(72) Inventors: Kevin BRECHTEL, Uehlfeld (DE); Katrin RAAKE, Rödermark (DE); Henning SCHRAMM, Hofheim am Taunus (DE)

(73) Assignee: Siemens Aktiengesellschaft, Munich (DE)

(21) Appl. No.: 15/558,749

(22) PCT Filed: Feb. 9, 2016
(86) PCT No.: PCT/EP2016/052665

§ 371 Date: Sep. 15, 2017

(30) Foreign Application Priority Data
Mar. 23, 2015 (DE) 10 2015 205 184.6

(51) Int. Cl. B01D 53/86; F22B 37/04; F22B 37/00; F23G 7/07; B01J 23/38; B01D 53/94

(52) U.S. Cl. CPC B01D 53/8637; F22B 37/04; F22B 37/008; B01D 2255/10; B01J 23/38; B01D 53/944; F23G 7/07

(57) ABSTRACT

A steam generator for a power plant sub-system, having at least one evaporator tube through which a flow medium can flow, as well as a number of heat exchanger surfaces formed by the surface of the evaporator tube, wherein at least parts of the/each heat exchanger surface are provided with a catalytically active coating for the exothermic decomposition of hydrocarbons. By means of the catalytic coating of the heat exchanger surfaces of the evaporator tubes, an increased heat requirement calculation can be carried out, without also having to accept the formation of unwanted harmful substances inside the steam generator.

### CROSS REFERENCE TO RELATED APPLICATIONS

This application is the US National Stage of International Application No. PCT/EP2016/052665 filed Feb. 9, 2016, and claims the benefit thereof. The International Application claims the benefit of German Application No. DE 102015205184.6 filed Mar. 23, 2015. All of the applications are incorporated by reference herein in their entirety.

### FIELD OF INVENTION

The invention relates to a steam generator of a power plant sub-system. The invention also refers to a method for operating a steam generator of a power plant sub-system.

### BACKGROUND OF INVENTION

In a power plant with a steam generator, a fuel gas which is produced on the burner side during the combustion of a fossil fuel, or a hot exhaust gas discharging from a gas turbine, is used for evaporating a flow medium inside the steam generator.

The steam generator, also referred to as a waste heat boiler, has evaporator tubes for evaporating the flow medium which are usually grouped or bundled together to form heat exchanger surfaces, the heating of which tubes leads to an evaporation of the flow medium which is conducted in the evaporator tubes. The steam which is generated by means of the steam generator during the evaporation is used in turn for example for an associated external process or particularly also for driving a steam turbine, for example in gas and steam power plant (combined cycle power plant, CCPP).

In a CCPP power plant, electric energy is generated by means of a number of gas turbines and a steam turbine which is connected downstream of this. The hot exhaust gases of the gas turbine flow through the (waste heat) steam generator in a fuel gas or exhaust gas passage and are used for generating steam in a water-steam cycle. The steam is then expanded via a conventional steam turbine process.

In certain CCPP power plants, an increased heat demand exists, for example on account of a peak load covering or a district heating disconnection. In order to cover this additional heat demand, recourse is currently made to a so-called auxiliary or supplementary firing system in the steam generator. To this end, burners are installed in the steam generator, in which burners fuels are combusted with the exhaust gases which originate from the gas turbine. As a result of the combustion, the exhaust gas is heated and the heat is fed to the water-steam cycle of the steam turbine via the heating surfaces or the heat exchanger surfaces. In this way, the output of the steam section of a gas and steam power plant is increased in a targeted manner.

However, during the combustion within the limits of such an auxiliary firing system, comparable to other firing systems, pollutants such as nitrogen oxide (NOx) and sulfur oxide (SOx) are developed in turn. Their development necessitates additional measures for maintaining prescribed emissions limit values. A current method for maintaining these emissions limit values lies in the removal of these pollutants by the use of a catalyst which is connected downstream to the auxiliary firing system or to the steam generator.

For reducing nitrogen oxides which are present in the exhaust gas or fuel gas, so-called de-NOx catalyst devices, which are arranged at a suitable place in the steam generator, are in common use. In such a catalyst device, the nitrogen oxide contained in the fuel gas or exhaust gas flowing past is reduced by the effect of a catalytic material and as a result of simultaneous injection of an ammonia solution, wherein water (H₂O) and elementary nitrogen (N₂) result. The method is also referred to as selective catalytic reduction (SCR).

In the case of such a method, it is disadvantageous that the catalyst device requires additional installation space and costly fastening structures, as a result of which the overall cost for the construction and installation of the steam generator increases. Existing old plants, as a result of the absence of installation space, can often only be retrofitted with comparatively high outlay, moreover.

### SUMMARY OF INVENTION

As a first object, the invention is based on disclosing a steam generator by means of which it is possible while reducing pollutant developments to achieve an improved level of steam generation.

As a second object, the invention is based on disclosing a method by means of which it is possible to operate a steam generator in such a way that while reducing pollutant developments an improved level of steam generation is achieved.

The first object is achieved according to the invention by means of a steam generator for a power plant sub-system, comprising at least one evaporator tube through which can flow a flow medium, and also comprising a number of heat exchanger surfaces which are formed by the surface of the evaporator tube, wherein the heat exchanger surface, or each heat exchange surface, is provided at least partially with a catalytically active coating for an exothermic decomposition of hydrocarbons.

In a first step, the invention is based on dispensing with an auxiliary firing system for pollutant minimization inside a steam generator. Accordingly, recourse has to be made to another possibility for generating additional heat in the steam generator.

In a second step, the invention recognizes that a targeted heat generation without additional pollutant development is possible if conditions are created inside the steam generator which benefit the execution of an exothermic reaction, that is to say a reaction during which heat is released. In this case, the invention uses the knowledge that the catalytic decomposition of hydrocarbons constitutes such an exothermically running reaction. In other words, during the decomposition of hydrocarbons on a catalyst surface energy is released, which energy is yielded to the environment in the form of heat.

In a third step, the invention is based on the consideration that it is possible to generate a usable heat surplus inside a steam generator if a catalyst surface is integrated into the steam generator, on which surface hydrocarbons are exothermically decomposed. To this end, the heat exchanger surfaces of the evaporator tube are especially provided with a catalytically active coating on which hydrocarbons are exothermically decomposed.

Since the catalytic coating is applied to the heat exchanger surfaces, the energy released during the exothermic decomposition can be dissipated directly via the evaporator tube, or each evaporator tube, of the steam generator. In this way, a desired additional heat demand in the steam generator is advantageously covered and especially without an auxiliary firing system.

Unlike an auxiliary firing system, that is to say combustion using oxygen depletion in the classical sense, no additional pollutants such as nitrogen oxide or sulfur oxide are created during an exothermic catalytic decomposition of hydrocarbons. In other words, as a result of the catalytic coating of the heat exchanger surfaces of the evaporator tubes an increased heat demand can also be taken into account in a simple and effective manner without the development of undesirable pollutants inside the steam generator having to be accepted in the process. The steam generation is improved as a result of additional heat input. However, the steam generator is operated free of an auxiliary firing system.

Furthermore, an existing steam generator can be retrofitted with little outlay since the application of the catalytically active coating can also be carried out in the case of already existing power plants. A constructional change of the steam generator is not necessary for this.

The heat which results during the decomposition or conversion of the hydrocarbons is advantageously dissipated in a direct manner. For this purpose, the heat exchanger surfaces are expediently designed for the transfer of heat, which is released during the decomposition of the hydrocarbons, to a flow medium which flows through the evaporator tube. The heat which results during the catalytic decomposition of the hydrocarbons on the heat exchanger surfaces, that is to say on the catalytically coated surfaces of the evaporator tube, or of each evaporator tube, is transferred basically without loss to the flow medium which circulates in the evaporator tubes. The thereby heated flow medium is especially used in a steam turbine process.

The heat exchanger surfaces which are formed by the surfaces of the evaporator tubes are expediently provided in at least one region with the catalytically active coating. Especially advantageous in this case are the regions which when an exhaust gas flows through an exhaust gas passage of the steam generator face the flowing exhaust gas. Alternatively, a full-faced coating is naturally also possible.

The evaporator tube, which is arranged inside the steam generator, is expediently part of a heat-steam cycle of a steam turbine. The heat released during the decomposition is fed into the water-steam cycle accordingly and therefore contributes to the targeted heating and, resulting from that, to the evaporation of the flow medium which is being circulated.

The catalytically active coating for the exothermic decomposition of hydrocarbons advantageously comprises at least one noble metal. As a result of using one or more noble metals, a catalytically active surface is provided, on which surface a hydrocarbon is selectively decomposed or converted, releasing energy in the form of heat.

The catalytically active coating advantageously comprises at least one noble metal which is selected from a group which contains gold (Au), silver (Ag), ruthenium (Ru), rhodium (Rh), palladium (Pd), osmium (Os), iridium (Ir) and platinum (Pt). In this case, a catalytically active coating with only one noble metal is equally advantageous as a catalytic coating which contains a plurality of noble metals, that is to say an alloy. For the decomposition of hydrocarbons, it is particularly advantageous if the catalytically active coating contains rhodium (Rh), palladium (Pd) and/or platinum (Pt).

In a further advantageous embodiment, the catalytically active coating is designed for the catalytic conversion of methane. The decomposition of methane on a surface consisting of noble metal is an extremely exothermic reaction in which methane is decomposed, forming carbon dioxide (CO₂) and water (H₂O). Advantageously, natural gas and/or biogas are introduced into the steam generator since these gases contain a high proportion of methane as well as additional hydrocarbons. Natural gas in particular contains a high methane proportion. Methane is advantageously decomposed on a catalytically active coating which contains rhodium (Rh), palladium (Pd) and/or platinum (Pt).

The hydrocarbons to be composed are advantageously introduced into the steam generator as part of a gas flow. For dosed of the hydrocarbons, or of a hydrocarbonaceous gas flow, the steam generator expediently comprises an injection device. Via the injection device, the desired quantity of hydrocarbons—especially as part of a gas flow when the contained quantity of hydrocarbons is known—can be dosed in a targeted manner into the steam generator, which quantity is required for producing the additionally required heat. The hydrocarbons, or the hydrocarbonaceous gas flow, are in this case expediently injected together with the fuel gas or the exhaust gas on the catalytically active coating and the hydrocarbons are decomposed there.

Depending on the gas flow rate and hydrocarbon proportion, the process heat generation can be adapted to the actual heat demand. As a result of the heat dissipation, the temperature of the catalytically active coating is limited so that the quantity of injected hydrocarbon is not subjected to any limit.

An alternative embodiment of the invention provides to use a catalytically active coating which in addition to the catalytic decomposition of hydrocarbons is at the same time designed for the catalytic conversion of carbon monoxide (CO) and/or of hydrogen (H₂). Carbon monoxide and hydrogen can be introduced via the exhaust gas of the gas turbine. Furthermore, carbon monoxide can also be contained in the hydrocarbonaceous gas flow. Hydrogen, the proportion of which is usually small, can also find its way from industrial processes into the steam boiler.

A catalytic coating which is suitable for the catalytic decomposition or conversion of carbon monoxide (CO) and/or of hydrogen (H₂) advantageously also comprises at least one noble metal which is selected from a group which contains gold (Au), silver (Ag), ruthenium (Ru), rhodium (Rh), palladium (Pd), osmium (Os), iridium (Ir) and platinum (Pt). Particularly suitable is a catalytically active coating which contains ruthenium (Ru), rhodium (Rh), palladium (Pd) and/or platinum (Pt).

The heat exchanger surface, or each heat exchanger surface, is expediently provided at least partially with a bonding agent. The bonding agent is applied to the heat exchanger surfaces in order to ensure a good and uniform adhesion of the catalytically active coating on the heat exchanger surfaces. As a bonding agent, metal organic compounds are advantageously used. Advantageously, a ceramic compound, especially on a base of titanium oxide (TiO₂), is used.

The second object of the invention is achieved according to the invention by means of a method for operating a steam generator of a power plant sub-system, wherein hydrocarbons are fed to a steam generator which comprises at least one evaporator tube, wherein the hydrocarbons are brought into contact with a number of heat exchanger surfaces which are formed by the surface of the evaporator tube and are provided at least partially with a catalytically active coating, and wherein the hydrocarbons, upon contact with the catalytically active coating, are exothermically decomposed on this.

The heat released during the decomposition of the hydrocarbons is advantageously transferred to a flow medium which flows through the evaporator tube. The flow medium is heated by the heat which results during the conversion or decomposition of the gaseous components, while the temperature of the catalytically active coating is limited toward its top end on account of the heat dissipation. The heat which results during the decomposition is expediently dissipated into the heat-steam cycle of a steam turbine, as a result of which the output of the steam section of a gas and steam power plant is increased in a targeted manner.

It is advantageous if a catalytically active coating with at least one noble metal is used. Advantageously used is a catalytically active coating which comprises at least one noble metal from a group which contains gold (Au), silver (Ag), ruthenium (Ru), rhodium (Rh), palladium (Pd), osmium (Os), iridium (Ir) and platinum (Pt).

Methane is especially advantageously decomposed on the catalytically active coating. To this end, the methane is expediently introduced into the steam generator as part of a gas flow, especially of a natural gas flow or a biogas flow. Via the quantity of methane or generally of decomposable hydrocarbons, the heat generation on the catalytically active coating is controlled. The hydrocarbons are in this case expediently injected into the steam generator. In an alternative embodiment, carbon monoxide and hydrogen are also converted on the catalytically active coating in addition to hydrocarbons.

For ensuring a durable and uniform coating, the heat exchanger surface, or each heat exchanger surface, is provided at least partially with a bonding agent. Advantageously used as a bonding agent are metal organic compounds.

The advantages which are stated for preferred embodiments of the steam generator can in this case be analogically transferred to corresponding embodiments of the method.

### BRIEF DESCRIPTION OF THE DRAWINGS

In the following text, exemplary embodiments of the invention are explained in more detail with reference to a drawing. In this case, in the drawing:

FIG. 1 schematically shows a steam generator in a side view, and

FIG. 2 shows a detail of the steam generator according to FIG. 1 in a plan view.

### DETAILED DESCRIPTION OF INVENTION

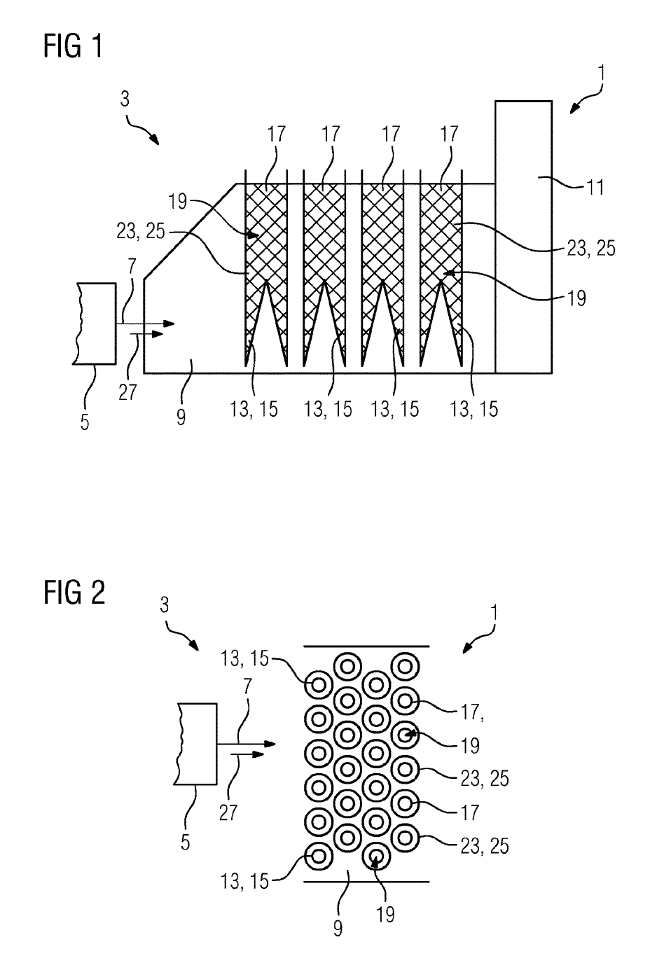

FIG. 1 schematically shows in a side view a steam generator 1 as part of a power plant sub-system 3, in the present case a steam turbine. A gas turbine 5 is connected upstream to the steam generator 1. From the gas turbine 5, exhaust gas 7 flows into the steam generator 1. The exhaust gas 7 flows through the steam generator 3 inside an exhaust gas passage 9, which on account of the horizontal design is also referred to as a horizontal gas duct, in the direction of a chimney which is designed as an exhaust duct or vertical duct 11. In the process, the exhaust gas 7 yields by heat transfer a high proportion of the heat contained within it to the heat exchanger surfaces 13 which are arranged inside the exhaust gas passage 9 and are formed by the surfaces 15 of the evaporator tubes 17 which are arranged in the steam generator 3.

As a result of this, the flow medium 19 which flows in the evaporator tubes 17 is heated and evaporated. The largely cooled exhaust gas 7, after its heat yield to the flow medium 19, in the present case water, leaves the steam generator 1 via the chimney 11. The steam which is generated in the evaporator tubes 17 is utilized in a water-steam cycle and expanded in a conventional steam turbine process, which is not described in more detail.

In the present case, all the heat exchanger surfaces 13 are fully provided with a bonding agent 23 and a catalytically active coating 25. The catalytically active coating 25 in the present case consists of platinum and serves for the exothermic decomposition of hydrocarbons. As a result of the exothermic decomposition of hydrocarbons, heat is generated inside the steam generator 1 in a targeted manner without pollutants such nitrogen oxide and/or sulfur oxide being formed in the process.

In the present case, natural gas is injected into the steam generator 1 via an injection device 27, which is shown schematically with reference to an arrow. Natural gas contains a high proportion of hydrocarbons and especially of methane. The methane which is contained in the natural gas flow is exothermically decomposed into carbon dioxide and water on the catalytically active coating 25 of the heat exchanger surfaces 13. The energy released in the process is yielded in the form of heat via the heat exchanger surfaces 13 to the flow medium 19 which flows in the evaporator tubes 17.

The heat is dissipated into the heat-steam cycle, as a result of which the output of the steam section of a gas and steam power plant is increased. Furthermore, as a result of the heat dissipation the temperature of the catalytically active coating 25 is limited.

Shown in FIG. 2 in a plan view is a detail of the steam generator 1 according to FIG. 1. To be seen with reference to this view are the evaporator tubes 17 which are arranged in the steam generator 1 and provided with the catalytically active coating 15. The exhaust gas 7 of the gas turbine 5 flows together with the methane in the exhaust gas passage 9 through the steam generator 1. The methane is decomposed on the catalytically active coating 25, wherein the heat released in the process is transferred to the flow medium 19 which flows in the evaporator tubes 17.

To be seen with reference to the present view is that the evaporator tubes 17 or the heat exchanger surfaces 13 which are formed by the surfaces 15 of the evaporator tubes 17 are completely coated. Basically, it is naturally also possible to coat only regions of the heat exchanger surfaces 13.

Overall, it is possible, as a result of the catalytically active coating 25 of the heat exchanger surfaces 13 of the evaporator tubes 17 to increase the process heat without having to accept the forming of undesirable pollutants inside the steam generator 1. The steam generator 1 is operated with targeted heat generation free of an auxiliary firing system.

1.-16. (canceled)

17. A steam generator for a power plant sub-system, comprising:
at least one evaporator tube, which is part of a heat-steam cycle of a steam turbine, through which can flow a flow medium, and
a number of heat exchanger surfaces which are formed by the surface of the evaporator tube,
wherein the heat exchanger surface, or each heat exchanger surface, is provided at least partially with a catalytically active coating for an exothermic decomposition of hydrocarbons,
wherein in the steam generator additional heat demand is covered without an auxiliary firing system.

18. The steam generator as claimed in claim 17,
wherein the heat exchanger surfaces are designed for the transfer of heat released during the composition of the hydrocarbons to a flow medium which flows through the evaporator tube.

19. The steam generator as claimed in claim 17,
wherein the catalytically active coating for the exothermic decomposition of hydrocarbons comprises at least one noble metal.

20. The steam generator as claimed in claim 17,
wherein the catalytically active coating comprises at least one noble metal which is selected from a group which contains gold (Au), silver (Ag), ruthenium (Ru), rhodium (Rh), palladium (Pd), osmium (Os), iridium (Ir) and platinum (Pt).

21. The steam generator as claimed in claim 17,
wherein the catalytically active coating is designed for the exothermic decomposition of methane.

22. The steam generator as claimed in claim 17, further comprising
an injection device for the dosing of hydrocarbons.

23. The steam generator as claimed in claim 17,
wherein the heat exchanger surface, or each heat exchanger surface, is provided at least partially with a bonding agent.

24. A method for operating a steam generator of a power plant sub-system, the method comprising:
feeding hydrocarbons to a steam generator which comprises at least one evaporator tube,
wherein the hydrocarbons are brought into contact with a number of heat exchanger surfaces which are formed by the surface of the evaporator tube and are provided at least partially with a catalytically active coating, and
wherein the hydrocarbons, upon contact with the catalytically active coating, are exothermically decomposed on this,
wherein the heat released during the exothermic decomposition is dissipated into the heat-steam cycle of a steam turbine, and
wherein in the steam generator additional heat demand is covered without an auxiliary firing system.

24. The method as claimed in claim 24,
wherein heat released during the decomposition of the hydrocarbons is transferred to a flow medium which flows through the evaporator tube.

25. The method as claimed in claim 24,
wherein at least one noble metal is used as the catalytically active coating.

26. The method as claimed in claim 24,
wherein use is made of a catalytically active coating which comprises at least one noble metal from a group which contains gold (Au), silver (Ag), ruthenium (Ru), rhodium (Rh),
palladium (Pd), osmium (Os), iridium (Ir) and platinum (Pt).

27. The method as claimed in claim 24,
wherein methane is exothermically decomposed on the catalytically active coating.

28. The method as claimed in claim 24,
wherein the hydrocarbons are injected into the steam generator.

29. The method as claimed in claim 24,
wherein the heat exchanger surface, or each heat exchanger surface, is provided at least partially with a bonding agent.
